(19) United States
(12) Patent Application Publication
(10) Pub. No.: US 2023/0399016 A1
(43) Pub. Date: Dec. 14, 2023

(54) MULTI-MODE VEHICLE CONTROLLER

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/840,255

(22) Filed: Jun. 14, 2022

(51) Int. Cl. B60W 60/00; B60W 40/09; B60W 40/04; B60W 10/20

(52) U.S. Cl. CPC B60W 60/0015; B60W 60/005; B60W 40/09; B60W 40/04; B60W 10/20; B60W 2510/0609; B60W 2540/30; B60W 2554/4046

(57) ABSTRACT

A system may include a vehicle controller, comprising: a hardware platform, comprising a processor and a memory; and instructions encoded within the memory to: provide an autonomous vehicle control module with at least L4 vehicle control capability; select a semi-autonomous operating mode that uses a subset of the L4 vehicle control capability; and operate a vehicle in the semi-autonomous operating mode.

### FIELD OF THE SPECIFICATION

The present disclosure relates to autonomous vehicles and more particularly, though not exclusively, to a multi-mode vehicle controller for an autonomous vehicle (AV).

### BACKGROUND

AVs, also known as self-driving cars, driverless vehicles, and robotic vehicles, are vehicles that use multiple sensors to sense the environment and move without human input. Automation technology in the AVs enables the vehicles to drive on roadways and to perceive the vehicle's environment accurately and quickly, including obstacles, signs, and traffic lights. The vehicles can be used to pick up passengers and drive the passengers to selected destinations. The vehicles can also be used to pick up packages and/or other goods and deliver the packages and/or goods to selected destinations.

AVs may be divided into various classes of autonomous control. For example, the Society of Automotive Engineers (SAE) provides a multilevel classification. The classification includes levels L0 through L5.
L0 is no automation.
L1 includes limited automation of a single system, such as steering or acceleration (e.g., cruise control). Adaptive or intelligent cruise control still qualifies at L1.
L2 includes partial driving automation. The AV controller may control both steering and acceleration, but a human user is behind the wheel, and can take back control at will.
L3 includes conditional driving automation. This is the lowest level at which the AV controller includes environmental detection capabilities, and can maintain full control of the vehicle for at least limited times. However, the driver is still responsible for operation of the vehicle, and should be prepared to take over control from the AV controller as necessary.
L4 includes high driving automation. The AV controller operates the vehicle in most circumstances, and can intervene if something goes wrong (e.g., emergency braking, or collision avoidance). L4 vehicles still have human controls, so a human operator can intervene if desired or necessary.
L5 vehicles are fully autonomous, and have no manual human controls (e.g., steering wheel, and accelerator).

### SUMMARY

A system may include a vehicle controller, comprising: a hardware platform, comprising a processor and a memory; and instructions encoded within the memory to: provide an autonomous vehicle control module with at least L4 vehicle control capability; select a semi-autonomous operating mode that uses a subset of the L4 vehicle control capability; and operate a vehicle in the semi-autonomous operating mode.

### BRIEF DESCRIPTION OF THE DRAWINGS

The present disclosure is best understood from the following detailed description when read with the accompanying FIGURES. In accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram illustrating an example AV.

FIG. 2 is a block diagram of selected elements of an AV controller.

FIG. 3 is a block diagram of a control module that may be provided as part of an AV controller.

FIGS. 4A and 4B are a flowchart of a method of operating a vehicle.

FIG. 5 is a flow chart of a method of operating an AV in autonomous mode.

FIG. 6 is a flowchart of a method of operating a vehicle in auto-steering node.

FIG. 7 is a flowchart of a method of providing auto-throttle.

FIG. 8 is a flowchart of a method of providing a driver-assist mode.

FIG. 9 is a block diagram of a hardware platform.

### DETAILED DESCRIPTION

Overview

The following disclosure provides many different embodiments, or examples, for implementing different features of the present disclosure. Specific examples of components and arrangements are described below to simplify the present disclosure. These are, of course, merely examples, and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

An AV manufacturer may provide vehicles and controllers capable of highly autonomous (e.g. L4 or greater) operation. However, the manufacturer may also be interested in providing lower-level systems, such as L2, L3, or L1 systems, which may provide different market opportunities from full L4 systems. Maintaining separate software stacks for L2, L3, and L4+ systems may be prohibitively expensive. However, at least some functions of L2 and L3 control may be treated as a subset of L4 functionality. Thus, vehicle controller software that provides full L4+ capability can be retrofitted with changes to make an L2 or L3 system. For example, this may be accomplished by providing low cost and low maintenance adjustments in parts of the AV system.

When the vehicle controller operates in an L2 or L3 mode, it may provide various functionality. For example, in follow mode, the AV planning and motion systems may be modified to restrict the AV to simple maneuvers. Planning can be modified to produce only straight paths. Similarly, if the system is in an auto-throttle mode, steering can be overridden by user input. When the system is in an auto-steer mode, the gas and brake pedals may be overridden by user inputs. In an overwatch mode, the AV may take over automatically only if a potentially unsafe or other special condition is predicted by the prediction system. An AV may also operate in a mode where a weighted combination of the behaviors described above can be observed. For example, the AV may operate in a mode where it observes 50% auto-throttle, and 50% auto-steer, where it makes its decision on steering and throttle with half influence from the driver, and half from the AV (i.e., steering and throttle inputs from driver and AV can be averaged). This may allow the driver to control the vehicle, but also aids in maintaining steady speed and steering.

Risk can be measured based on the outcome of the planning. In the overwatch mode, the behavior of the vehicle controller can be modified according to a driver profile. For example, the L4 AV software may include a machine learning model that can be used to profile other vehicles operating on the road. This same machine learning model can be used to observe the behavior of the operator of the vehicle. Thus, the model can measure risk based on the outcome of planning. The vehicle controller may predict behavior of the vehicle similar to how it predicts the behavior of other vehicles, in using the same machine learning models. For example, the controller may predict right-of-way, stopping distance, reaction time, and similar. The behavior of the operator of the vehicle can be learned from historical data and the identity of the driver. In some cases, sensors may be provided to identify the user based on visual inputs, height, weight, or manual selection. Thus, the AV may be able to modify its behavior to adjust and react to a plurality of known drivers and their predicted behavior.

Embodiments of the present specification include the ability to retrofit a fully self-driving system into an L2 or L3 system by making low cost and low maintenance modifications to prediction, planning, and controls. Embodiments also provide operation in an auto-throttle mode where steering is overridden by the human driver. Embodiments also include operation in an auto-steer mode where gas and brake pedals are overridden by the human driver. Embodiments also provide operation in overwatch mode (not exclusive to the other modes) where the vehicle controller calculates a risk during planning and takes over from the human driver based on the calculated risk. Embodiments also provide the ability to predict the behavior of the vehicle using the same models that are used for predicting other vehicles' behavior. Embodiments also provide the ability to learn the behavior of the vehicle's operator by using historical data from the driver and from the driver's identity. Embodiments also include a mode where a weighted combination of any of the above behaviors may be observed.

The foregoing can be used to build or embody several example implementations, according to the teachings of the present specification. Some example implementations are included here as nonlimiting illustrations of these teachings.

### DETAILED DESCRIPTION OF THE DRAWINGS

A system and method for providing a multi-mode vehicle controller will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

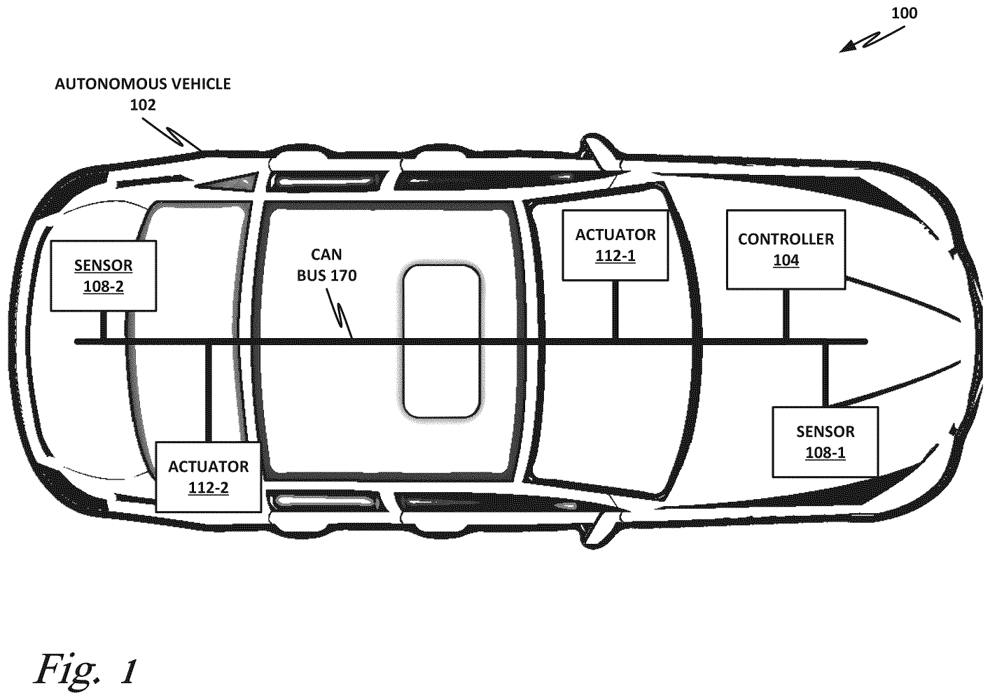

FIG. 1 is a block diagram 100 illustrating an example AV 102. AV 102 may be, for example, an automobile, car, truck, bus, train, tram, funicular, lift, or similar. AV 102 could also be an autonomous aircraft (fixed wing, rotary, or tiltrotor), ship, watercraft, hover craft, hydrofoil, buggy, cart, golf cart, recreational vehicle, motorcycle, off-road vehicle, three- or four-wheel all-terrain vehicle, or any other vehicle. Except to the extent specifically enumerated in the appended claims, the present specification is not Intended to be limited to a particular vehicle or vehicle configuration.

In this example, AV 102 includes one or more sensors, such as sensor 108-1, and sensor 108-2. Sensors 108 may include, by way of illustrative and nonlimiting example, localization and driving sensors such as photodetectors, cameras, Radio Detection and Ranging (RADAR), Sound Navigation and Ranging (SONAR), Light Detection and Ranging (LIDAR), GPS, inertial measurement units (IMUs), synchros, accelerometers, microphones, strain gauges, pressure monitors, barometers, thermometers, altimeters, wheel speed sensors, computer vision systems, biometric sensors for operators and/or passengers, or other sensors. In some embodiments, sensors 108 may include cameras implemented using high-resolution imagers with fixed mounting and field of view. In further examples, sensors 108 may include LIDARs implemented using scanning LIDARs. Scanning LIDARs have a dynamically configurable field of view that provides a point-cloud of the region intended to scan. In still further examples, sensors 108 includes RADARs implemented using scanning RADARs with dynamically configurable field of view.

AV 102 may further include one or more actuators 112. Actuators 112 may be configured to receive signals and to carry out control functions on AV 102. Actuators may include switches, relays, or mechanical, electrical, pneumatic, hydraulic, or other devices that control the vehicle. In various embodiments, actuators 112 may include steering actuators that control the direction of AV 102, such as by turning a steering wheel, or controlling control surfaces on an air or watercraft. Actuators 112 may further control motor functions, such as an engine throttle, thrust vectors, or others. Actuators 112 may also include controllers for speed, such as an accelerator. Actuators 112 may further operate brakes, or braking surfaces. Actuators 112 may further control headlights, indicators, warnings, a car horn, cameras, or other systems or subsystems that affect the operation of AV 102.

A controller 104 may provide the main control logic for AV 102. Controller 104 is illustrated here as a single logical unit and may be implemented as a single device such as an electronic control module (ECM) or other. In various embodiments, one or more functions of controller 104 may be distributed across various physical devices, such as multiple ECMs, one or more hardware accelerators, artificial intelligence (AI) circuits, or other.

Controller 104 may be configured to receive from one or more sensors 108 data to indicate the status or condition of AV 102, as well as the status or condition of certain ambient factors, such as traffic, pedestrians, traffic signs, signal lights, weather conditions, road conditions, or others. Based on these inputs, controller 104 may determine adjustments to be made to actuators 112. Controller 104 may determine adjustments based on heuristics, lookup tables, AI, pattern recognition, or other algorithms.

Various components of AV 102 may communicate with one another via a bus such as controller area network (CAN) bus 170. CAN bus 170 is provided as an illustrative embodiment, but other types of buses may be used, including wired, wireless, fiberoptic, infrared, WiFi, Bluetooth, dielectric waveguides, or other types of buses. Bus 170 may implement any suitable protocol. for example, in some cases bus 170 may use transmission control protocol (TCP) for connections that require error correction. In cases where the overhead of TCP is not preferred, bus 170 may use a one-directional protocol without error correction, such as user datagram protocol (UDP). Other protocols may also be used. Lower layers of bus 170 may be provided by protocols such as any of the family of institute of electrical and electronics engineers (IEEE) 802 family of communication protocols, including any version or subversion of 802.1 (higher layer local area network (LAN)), 802.2 (logical link control), 802.3 (Ethernet), 802.4 (token bus), 802.5 (token ring), 802.6 (metropolitan area network), 802.7 (broadband coaxial), 802.8 (fiber optics), 802.9 (integrated service LAN), 802.10 (interoperable LAN security), 802.11 (wireless LAN), 802.12 (100VG), 802.14 (cable modems), 802.15 (wireless personal area network, including Bluetooth), 802.16 (broadband wireless access), or 802.17 (resilient packet ring) by way of illustrative and nonlimiting example. Non-IEEE and proprietary protocols may also be supported, such as for example, InfiniBand, FibreChannel, FibreChannel over Ethernet (FCoE), Omni-Path, Lightning bus, or others. Bus 170 may also enable controller 104, sensors 108, actuators 112, and other systems and subsystems of AV 102 to communicate with external hosts, such as internet-based hosts. In some cases, AV 102 may form a mesh or other cooperative network with other AVs, which may allow sharing of sensor data, control functions, processing ability, or other resources.

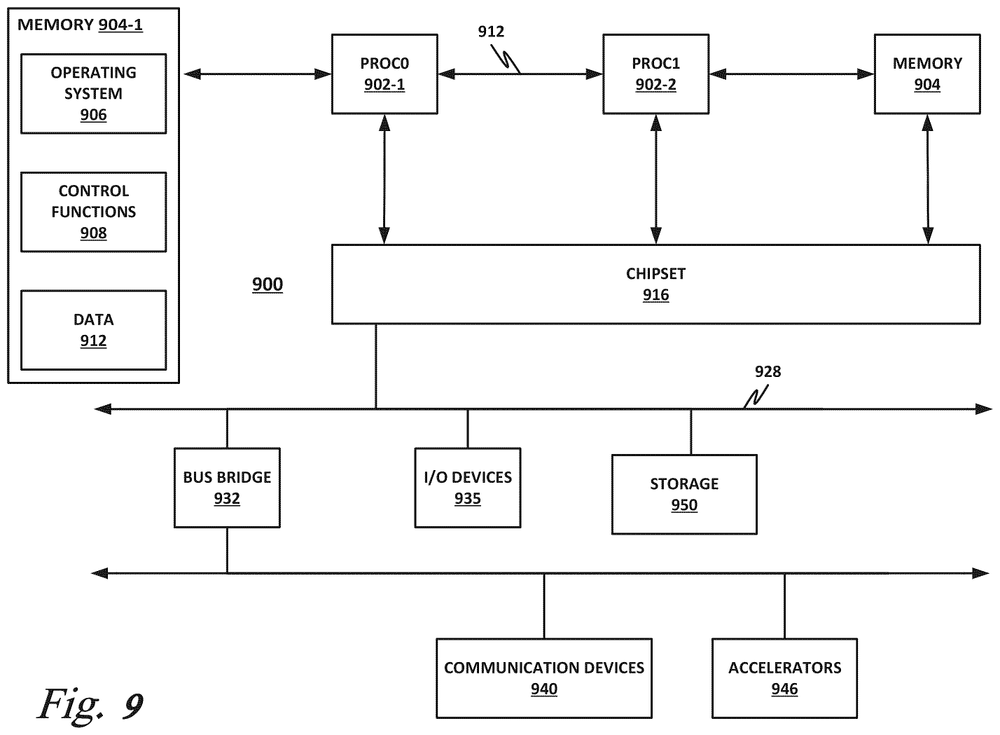

Controller 104 may control the operations and functionality of AV 102, or one or more other AVs. Controller 104 may receive sensed data from sensors 108, and make onboard decisions based on the sensed data. In some cases, controller 104 may also offload some processing or decision making, such as to a cloud service or accelerator. In some cases, controller 104 is a general-purpose computer adapted for I/O communication with vehicle control systems and sensor systems. Controller 104 may be any suitable computing device. An illustration of a hardware platform is shown in FIG. 9, which may represent a suitable computing platform for controller 104. In some cases, controller 104 may be connected to the internet via a wireless connection (e.g., via a cellular data connection). In some examples, controller 104 is coupled to any number of wireless or wired communication systems. In some examples, controller 104 is coupled to one or more communication systems via a mesh network of devices, such as a mesh network formed by AVs.

According to various implementations, AV 102 may modify and/or set a driving behavior in response to parameters set by vehicle passengers (e.g., via a passenger interface) and/or other interested parties (e.g., via a vehicle coordinator or a remote expert interface). Driving behavior of an AV may be modified according to explicit input or feedback (e.g., a passenger specifying a maximum speed or a relative comfort level), implicit input or feedback (e.g., a passenger's heart rate), or any other suitable data or manner of communicating driving behavior preferences.

AV 102 is illustrated as a fully autonomous automobile but may additionally or alternatively be any semi-autonomous or fully autonomous vehicle. In some cases, AV 102 may switch between a semi-autonomous state and a fully autonomous state and thus, some AVs may have attributes of both a semi-autonomous vehicle and a fully autonomous vehicle depending on the state of the vehicle.

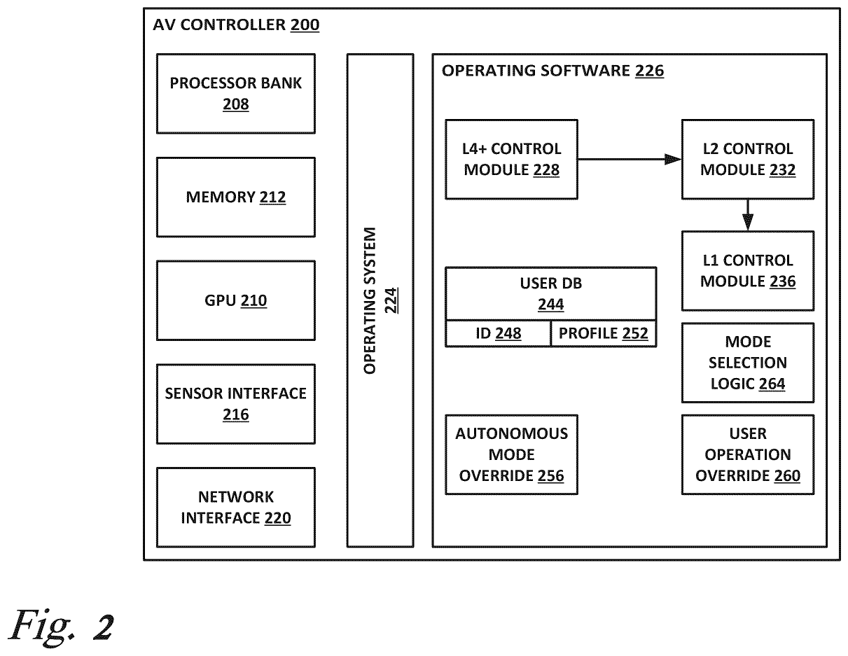

FIG. 2 is a block diagram of selected elements of an AV controller 200. AV controller 200 may be a controller that controls a vehicle that is to operate in L4, L3, L2, or L1 mode, or any other appropriate hybrid or intermediate mode. For example, a single AV could be configured with the ability to operate in any mode between L1 and L4 depending on user preferences. In other embodiments, a vehicle may operate in only one of those modes, or only a subset of those modes, but may provide control functions that are a subset of a full autonomous or L4 mode.

AV controller 200 may be a monolithic AV controller or may be one of a bank of redundant AV controllers.

By way of illustration, AV controller 200 includes a number of blocks as illustrated. These blocks may be provided by appropriate hardware, software, and/or firmware. The illustration of certain blocks as separate from one another does not necessarily indicate a physical separation of those functions, and the inclusion of certain blocks within other blocks does not necessarily imply a specific hierarchy. Rather, the blocks illustrated here are presented in a logical manner that illustrates certain functionality. In various embodiments, the blocks may be arranged in a different manner.

AV controller 200 includes a processor bank 208. Processor bank 208 may include one or more microprocessors, microcontrollers, DSPs, or other controllers. Processors within processor bank 208 may, in some cases, the specialized processors designed for use in AV systems.

Memory 212 may provide both volatile and nonvolatile memory for AV controller 200. Memory 212 can include random-access memory, storage, and any other memory architecture. Additional details of a hardware platform are illustrated in FIG. 9, and the teachings of FIG. 9 below may be generally applicable to the architecture of AV controller 200.

AV controller 200 may also include one or more GPUs 210. GPUs 210 may be used to drive displays for the user and can also be used to provide certain machine learning functions, such as image processing, or running a machine learning model.

Sensor interface 216 provides AV controller 200 an interface to various sensors and actuators, such as those illustrated in FIG. 1 (e.g., sensors 108, and actuators 112).

Network interface 220 may provide an interface to a network, such as CAN bus 170 of FIG. 1, and/or to a wired or wireless network that allows AV controller 200 to communicate with an external network.

Operating system 224 may provide low-level access to hardware and software services for AV controller 200. Operating system 224 may be an appropriate embedded and/or real-time operating system.

Operating software 226 provides a suite of software services that carry out the various functions of AV controller 200. Operating software 226 includes various levels of control modules. For example, L4+ control module 228 provides autonomous control at L4 or higher as defined by SAE. L4 control module 228 may represent the full autonomous capability of operating software 226 as provided to AV controller 200.

L2 control module 232 may provide a subset of features of L4+ control module 228. Similarly, L1 control module 236 may provide a subset of capabilities of L2 control module 232 and/or L4+ control module 228. Operating software 226 may also provide other levels of control, such as an L3 control module, and/or an L0 control module, which would provide full manual control by the operator.

Mode selection logic 264 may be used to select one of the operating modes, such as for L4+ control module 228, L2 control module 232, or L1 control module 236. Depending on the use case, mode selection logic 264 could provide dynamic switching between the various modes, such as in a vehicle that has L4+ capability but that also provides the ability for manual user operation. In other cases, a vehicle has only a subset of the autonomous control capabilities, and mode selection logic 264 may be hardcoded, such as via a read-only memory (ROM), fusing, or other hard coding technology, to provide only one level of control, such as L1 or L2, based on the vehicle's inherent capabilities.

A user database 244 may include a table that includes fields, such as a user ID 248 and a user profile 252. User DB 244 may be populated by a machine learning model, which may be part of L4+ control module 228, or some other appropriate software. This machine learning model may be designed initially to observe the behavior of other vehicles on the road as part of a prediction model that is used to provide responses to the other vehicles in L4 operating mode. In this case, the machine learning model can also be used to observe the AV (also known as the “ego vehicle”) and to profile the user's operation of the vehicle. User DB 244 may also be configured to recognize multiple users who are known drivers of the vehicle, and to provide individual profiles for the multiple users. User DB 244 may also include information to identify a particular user, such as via facial recognition, voice recognition, height, weight, fingerprint, other biometrics, or by some other factor.

When AV controller 200 is operating in L4 mode, by design, the user has no input to the operation of the vehicle. However, in L1 or L2 mode, the AV controller 200 is designed to only assist the user in the operation of the vehicle. In that case, the human user is the primary operator, and AV controller 200 serves merely a support function. Thus, in some cases, a user operation override 260 may be provided, such as to respond to an emergency case (such as a detected danger) or to a special case (such as a parking assist). For example, if AV controller 200 detects that a vehicle in front of the ego vehicle is hard braking and that there is insufficient time for the human operator to respond, user operation override 260 may take control of the vehicle to brake, avoid, or otherwise provide a safety function.

Autonomous mode override 256 is configured to receive human inputs and to override autonomous operation of the vehicle. For example, in an auto-throttle mode, the user may apply the brake and/or the accelerator, in which case the auto-throttle may be at least temporarily overridden by the human input. In an auto-steering mode, if the user operates the steering wheel, this may at least temporarily override the auto-steering function. Depending on the level of operation, the autonomous operation may have different levels of capability. For example, a classic case of L1 operation is the well-known cruise control commonly found on most vehicles. Cruise control allows a user to set a desired speed, and the cruise control will then operate the accelerator to keep the vehicle at that speed if the vehicle is below that speed. Generally, if the user taps the brake, then the cruise control is canceled. If the user pushes on the accelerator, the vehicle may accelerate above the set speed. When the user lets off the accelerator, the vehicle is allowed to naturally fall back to the desired cruise control speed.

L1 operation may provide, for example, a more sophisticated version of auto-throttle than simple cruise control. In this case, the user may set a desired speed, and the AV controller may provide more sophisticated responses. For example, if the user sets a throttle in L1 cruise control, then the vehicle can run up on a slower vehicle in front of it and the user must manually brake. But in L2 control, cameras and other sensors may be used to detect that the vehicle in front of the ego vehicle is slower and provide a safe following distance.

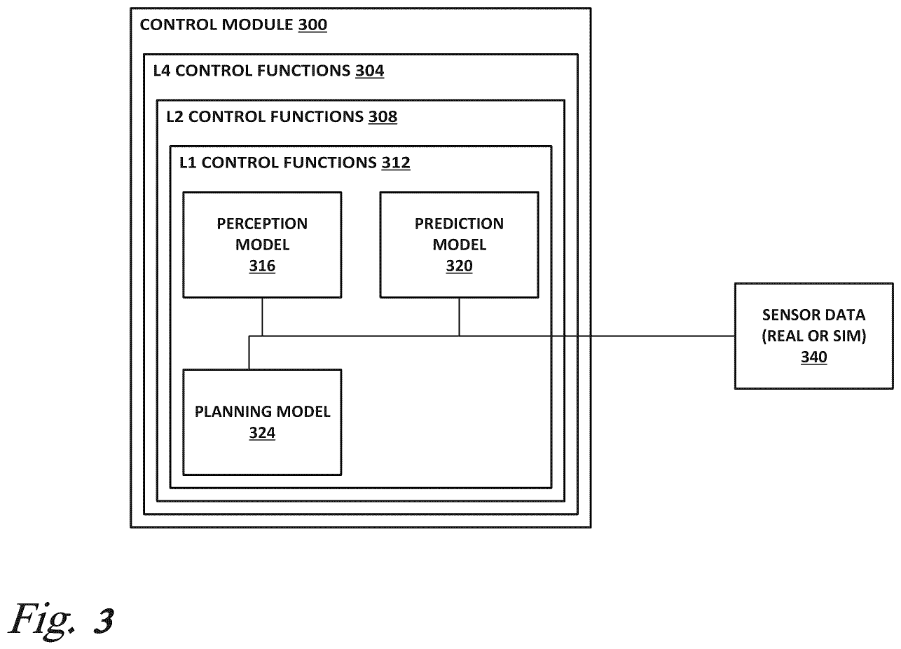

FIG. 3 is a block diagram of a control module 300 that may be provided as part of an AV controller. For example, control module 300 may conceptually be thought of as part of operating software 226 of FIG. 2.

Control module 300 includes an L4 control function 304. An L2 control function 308 is provided as a subset of at least some functions of L4 control function 304. An L1 control function 312 provides a subset of at least some control functions 308. Note that the illustration here of subsets of control functions is not necessarily a strict or exact subset architecture. For example, an L1 control function may include some lesser specialized functions that are not a subset of L2 or L4 control functions but that are used to adapt that subset of functions to the special case of L1 control.

The control functions illustrated here include a perception model 316, a prediction model 320, and a planning model 324. Again, it should be noted that the models illustrated herein may have certain functionality spread across L2, L3, and/or L4 control.

Perception model 316 receives sensor data 340, which may be real or simulated sensor data and is used to create a perception of the real environment. For example, perception model 316 may use computer vision to recognize other vehicles, traffic signs, traffic conditions, environmental factors, or similar. Perception model 316 builds a model of the ego vehicle and the world around it.

Prediction model 320 may then be used to predict the path of the ego vehicle as well as other vehicles, obstacles, traffic conditions, and other conditions. Prediction model 320 provides the probability of various outcomes based on the model of the environment built by perception model 316.

Planning model 324 may then be used to build a plan for the operation of the ego vehicle based on the predictions made by prediction model 320 according to the model built by perception model 316. The L2, L3, and/or L4 control functions can then build actuator inputs to control the vehicle based on the plan built by planning model 324.

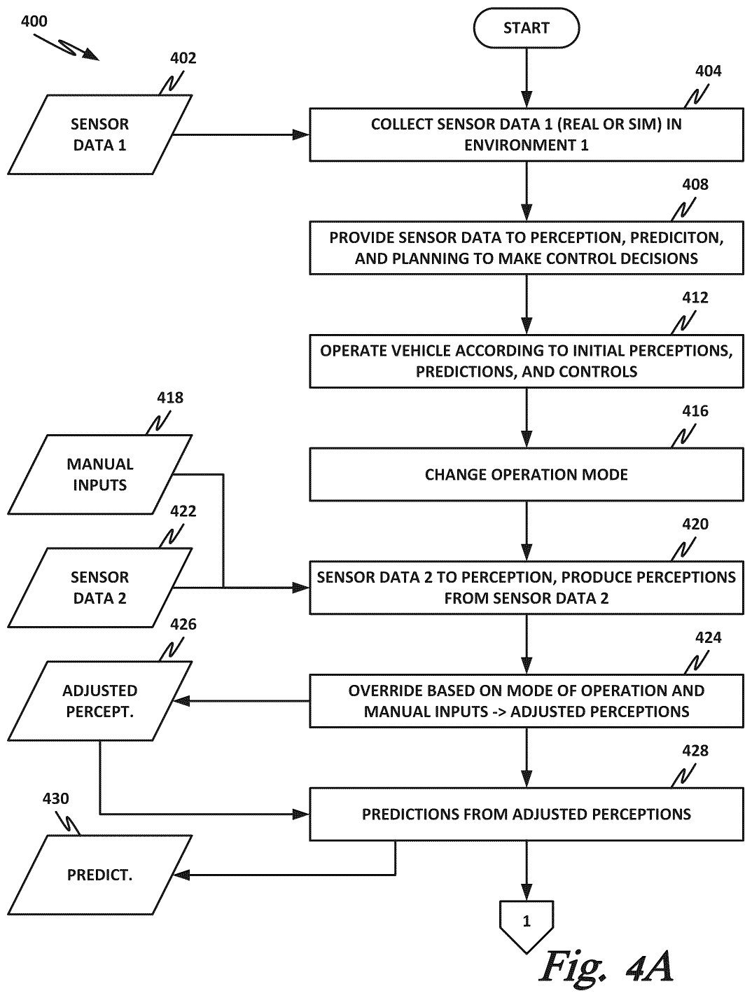

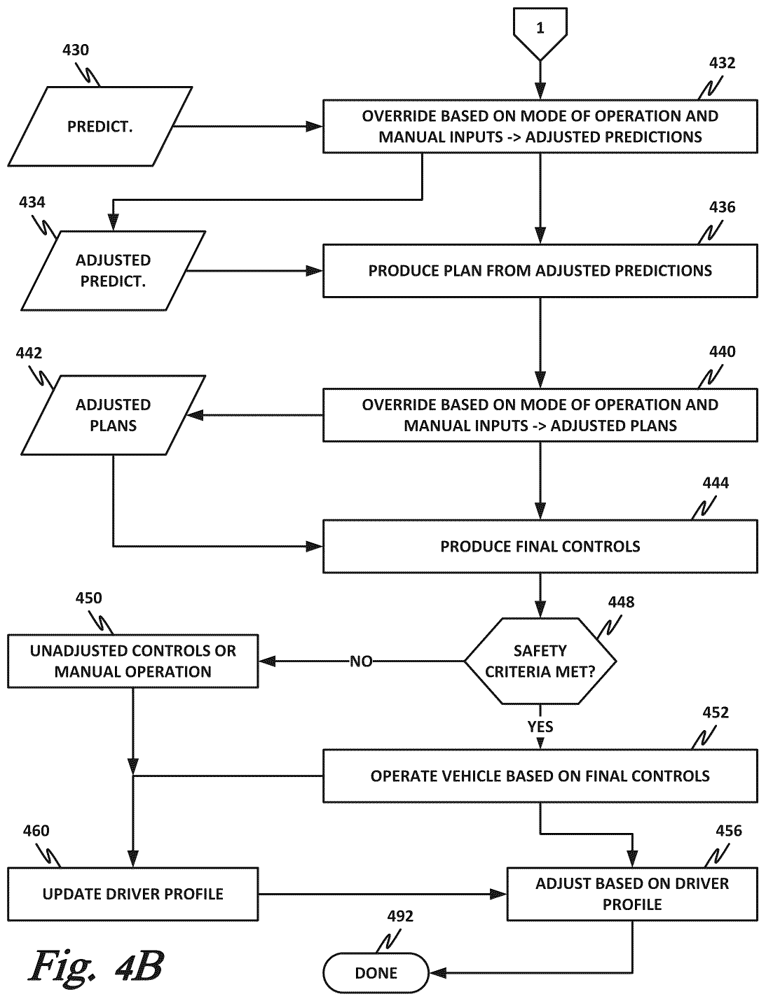

FIGS. 4A and 4B are a flowchart of a method 400. Method 400 illustrates selected elements of adapting an AV controller to operate in a plurality of available modes.

It should be noted that method 400 may be performed (wholly or partially) within the vehicle itself or may also be performed in a simulated environment, such as in a cloud ecosystem. The modified AV controller software could then be exported to a real AV controller for operation in a vehicle.

In block 404, the AV controller collects sensor data 1-402. Sensor data 1-402 may come from the various sensors of the AV, such as sensors 108 illustrated in FIG. 1 above. These are collected in a first environment called environment 1. As described above, this may be a real or a simulated environment. In the simulated environment, sensors may be simulated sensors, which are mathematical and algorithmic models of how the actual sensor operate. Simulated environment may be reconstruction of real environments, which may or may not be modified to achieve certain simulation goals. For example, if the simulation goal is to test the AV in the presence of rare events, those rare events may be reenacted in the simulation environment, which produces sensor data that relate to the rare events.

In block 408, the AV controller provides the sensor data to its perception, prediction, and planning modules to make control decisions based on sensor data 1-402.

In block 412, the AV controller operates the real or simulated vehicle according to the initial perceptions, predictions, and controls.

In block 416, the driver or some other entity may change the mode of operation, such as by the driver entering an auto-steering, auto-throttle, driver-assist, or other mode. The mode could be changed also when an emergency event or other intervening event happens. The mode can be a combination of auto-steering, auto-throttle, driver-assist modes where a weighted average of controls from different modes are applied on the AV.

In block 420, during an automated mode, the AV controller receives sensor data 2-422, as well as manual inputs 418. Manual inputs 418 may include, for example, the user manually entering steering or throttle inputs via the steering wheel, accelerator, and/or brakes. The manual inputs 418 and sensor data 2-422 are provided to the perception module to produce perceptions from sensor data 2-422.

In block 424, the perception processing may be adjusted based on the mode. For example, in auto-steer mode, processing may be focused on the planned path or forward motion of the vehicle. In an overwatch mode (e.g., a driver-assist), focus may be on processing all around to watch for emergency conditions. The AV controller may override predictions based on the mode of operation and manual inputs to produce adjusted perceptions 426.

In block 428, the system will make predictions 430 from adjusted perceptions 426 to provide adjusted predictions 430.

In block 432, the system receives predictions 430. These may account, for example, for the user's manual inputs. The predictions may be adjusted according to the operating mode. Predictions of other objects may also be adjusted to compensate for the safety characteristics of the mode. For example, adjustments may be more predictive in an overwatch mode. Predictions may also include the user profile, which may have been trained to observe operation of other vehicles on the road. However, this can also be used to observe the operation of the ego vehicle by the user and can be used to adjust the predictions.

The predictions module may produce adjusted predictions 434.

In block 436, the AV controller may provide the adjusted predictions to the planning module to produce a plan from the adjusted predictions.

In block 440, the system may override the plan based on the modes of operation and manual inputs to produce adjusted plans. For example, the AV could alert the driver if the driver has the right-of-way and the driver is not moving. Alternatively, the AV could alert the driver if it is not the driver's right-of-way and the driver is moving. As before, the adjusted plans 442 may rely in part on the user profile as determined by a machine learning model.

In block 444, the AV controller may receive adjusted plans 442 and produces final controls for the system. Note that during the adjustment of perceptions, predictions, plans, and controls, a safety margin may be calculated for the adjustment. In embodiments, the adjustment may be applied only if the safety criterion is met. For example, in auto-throttle mode, steering from the driver overrides the auto-throttle control. In auto-steer mode, gas and brake inputs from the driver overrides the automatic gas and brake controls. In overwatch mode, a safety risk may be calculated and the AV may take over controls only in unsafe situations or when expressly directed by the user, such as in a park-assist mode. The safety threshold for the takeover may optionally be adjusted by the driver or may be adjusted automatically according to the driver profile.

In block 448, the system may determine whether the safety criteria have been met. If safety criteria have not been met, then in block 450, the unadjusted controls may be used or manual operation may be used. The safety criteria may be based on a set of rules or a machine learning model that predicts safety given the perceptions, predictions, plans, controls, and user input. For example, a safety rule may be based on how fast the AV is moving. If the speed of AV is beyond a certain limit in the present environment conditions, it may be deemed unsafe. As another example, if the steering is set to a value that is too high given the AV speed, it may be deemed unsafe. The machine learning model may be a critical path model that is aimed to make a safety prediction using the least amount of compute resources.

Returning to block 448, if the safety criteria were met, then in block 452, the system may operate the vehicle based on the final adjusted controls. For example, final adjusted controls may be commanding the vehicle to accelerate or decelerate at a certain rate, or steer right or left at a certain rate.

In block 460, the system may update the driver profile according to the safety criteria and the manual operation of the vehicle. For example, if the driver prefers to drive at higher speeds, the system may calculate a preferred adjustment to speed. As another example, if the driver intervenes when the speed exceeds a certain value in certain environment, system may drive slower to make the driver more comfortable in that environment.

In block 456, the system may make adjustments based on the driver profile.

In block 460, the system may update the driver profile according to the safety criteria and the manual operation of the vehicle.

In block 492, the method is done.

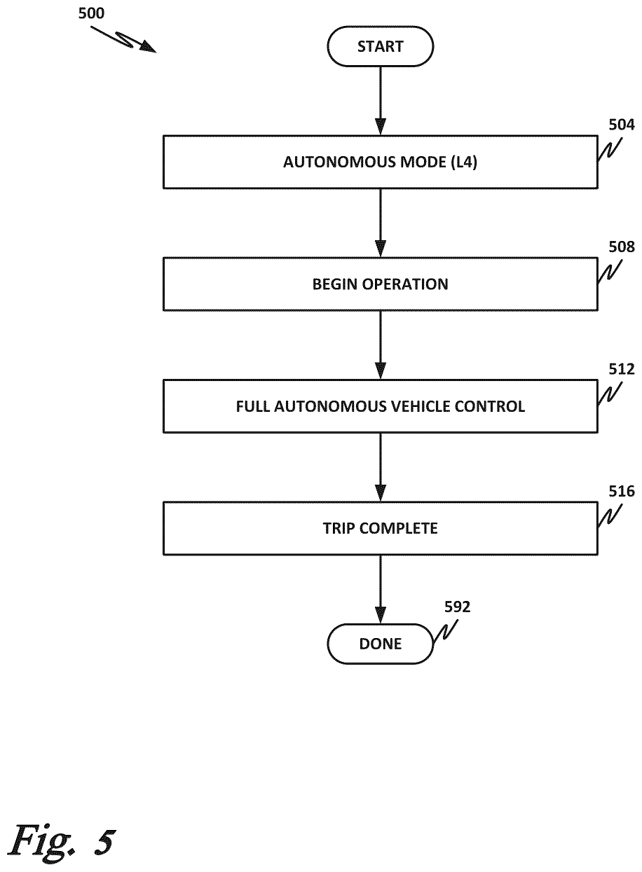

FIG. 5 is a block diagram of a method 500 of operating an AV in autonomous mode, which may be in L4 or L4+ mode.

In block 504, the vehicle enters autonomous (L4+) mode.

In block 508, the vehicle begins operation in the autonomous mode. The activation of the autonomous mode may be by user manual input or by system auto-activation based on a certain criteria being met.

In block 512, the AV provides full autonomous vehicle control throughout the duration of the drive.

In block 516, the trip is complete. In block 592, the method is done.

Notably, the vehicle control functions provided by the AV in method 500 may include certain subset operations or modules that are useful for L1 or L2 control.

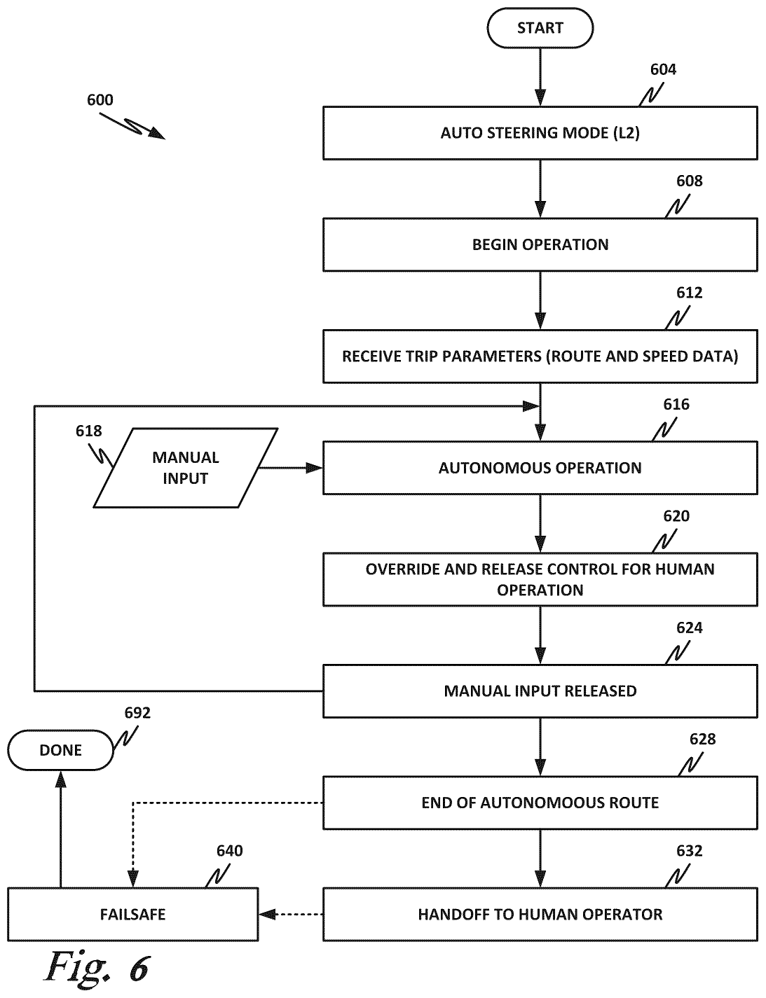

FIG. 6 is a flowchart of a method 600 of operating a vehicle in auto-steering node, which may be in L2 mode.

In block 604, the vehicle enters the auto-steering or L2 mode.

In block 608, the vehicle begins operation.

In block 612, the AV controller receives trip parameters for the steering control portion of the trip. This may include, for example, a route, and speed data. For example, this could be a lane-following mode or operation on a stretch of freeway that is mostly straight in which it is reasonable to assist the driver.

In block 616, the AV controller begins autonomous operation. Autonomous operation continues, so long as the trip has not been completed and there are no manual inputs.

In block 620, the AV controller receives a manual input 618. The manual input could include the user taking control of the steering wheel, pressing on the accelerator, or pressing on the brake, by way of illustrative and nonlimiting example. In the case of manual input 618, and optionally in case that the manual input exceeds a certain threshold (e.g., to prevent releasing autonomous control if the user merely brushes the steering wheel or a pedal), the AV controller overrides autonomous operation and releases control for human operation.

In block 624, the manual input is released, such as if the user releases the steering wheel or removes pressure from the brake or accelerator pedals. In this case, in block 616, the AV resumes autonomous operation. Alternatively, the autonomous operation resumes only with a prompt by the user.

In block 628, the system reaches the end of the autonomous route.

In block 628, the vehicle reaches the end of the autonomous route or some other condition indicates that the autonomous operation should terminate.

In block 632, the system hands control back over to the human operator. Note that a failsafe mechanism 640 may be provided, such as in the case where the user is not alert and does not timely assume control of the vehicle. In that case, the failsafe may seek a safe operating condition, such as finding a place where it can pull over and stop or continuing to autonomously operate the vehicle until a safe place to stop can be found.

In block 692, the method is done.

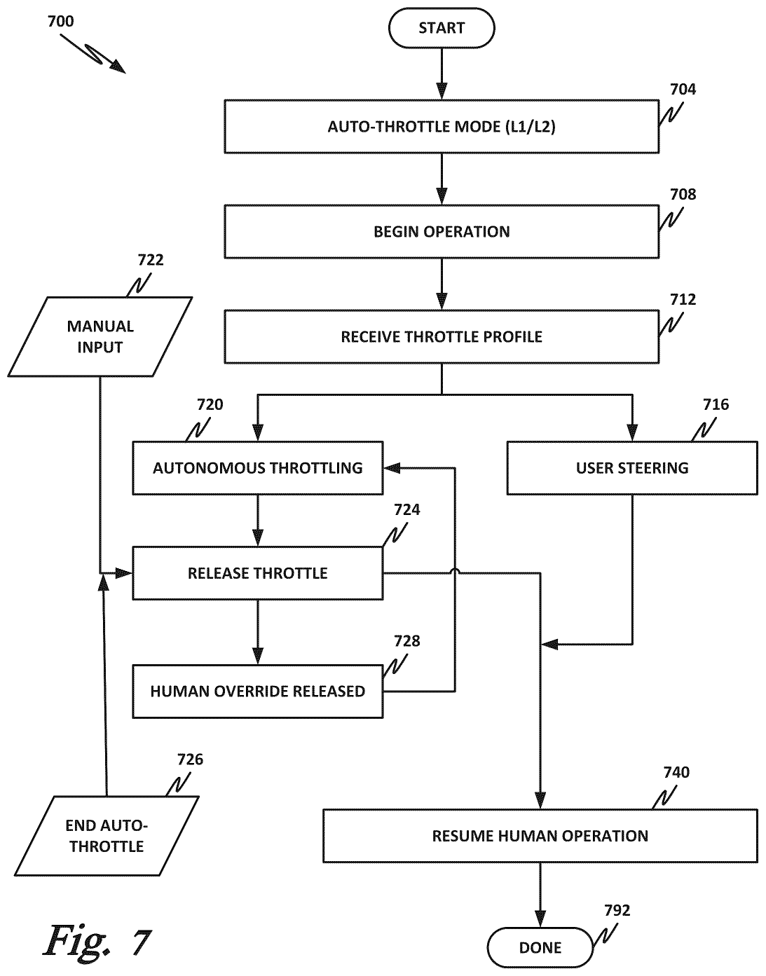

FIG. 7 is a flowchart of a method 700. Method 700 illustrates an auto-throttle operation, which may be, for example, an L1 or L2 mode.

Starting in block 704, the system enters the auto-throttle mode, which may be an L1 to L2 mode. In some cases, classic cruise control can be considered an auto-throttle mode, although more modern vehicles may provide a more sophisticated auto-throttle option.

In block 708, the system begins operation.

In block 712, the AV controller receives a throttle profile, which may include, for example, a desired auto-throttle speed, and optionally may include certain override information for the auto-throttle.

In block 716, because this is an auto-throttle mode, the user manually provides the steering. In parallel, in block 720, the AV controller provides autonomous throttling.

In block 722, the system may receive a manual input, such as the user pressing the brake or the accelerator or turning off the auto-throttle mode. In that case, in block 724, the AV controller releases the throttle and allows it to be controlled by the human input.

In block 728, the human override may be released, which allows the system to return to autonomous throttling in block 720.

Alternatively, in block 726, the system may end auto-throttle operation, such as by the user tapping the brake, turning off cruise control, or supposedly turning off auto-throttle. In that case, in block 724, the AV controller may release the throttle to human control.

In block 740, after auto-throttle has been released, then the human may continue to operate the vehicle manually.

In block 792, the method is done.

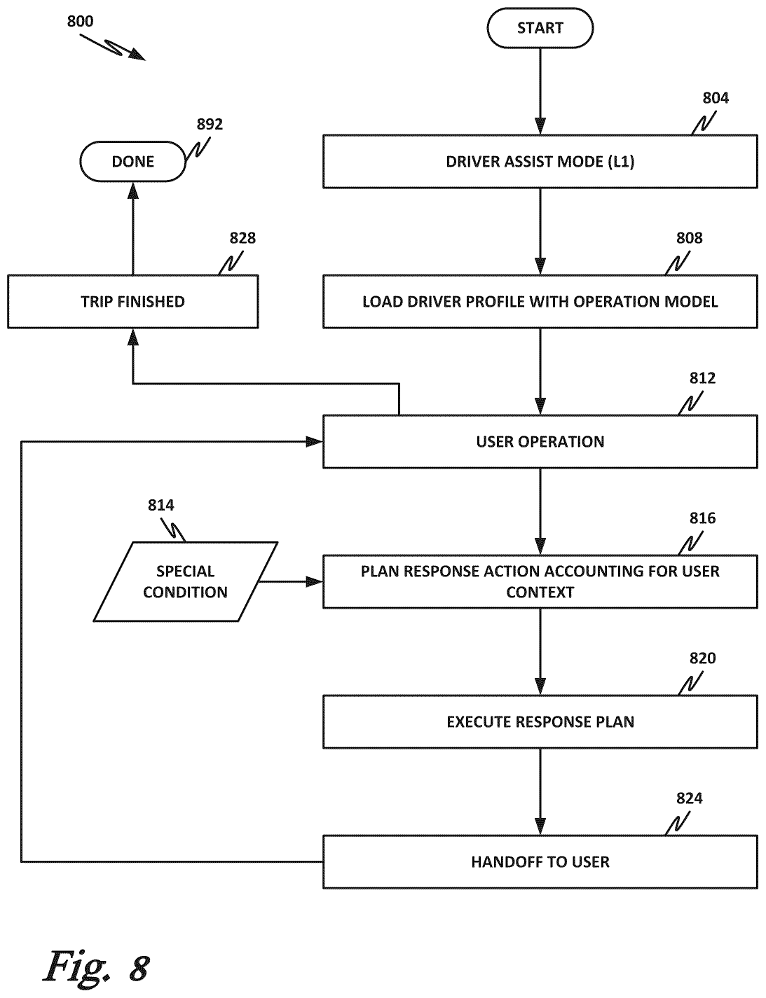

FIG. 8 is a flowchart of a method 800 of providing a driver-assist mode. Driver-assist mode may be considered an L1 mode and may respond to emergencies or provide other assistance, such as parking assist, lane-following assist, or other assist functions.

In block 804, the system enters driver-assist L1 mode.

In block 808, if a driver profile is included, including an ML-based driver profile, then the driver profile may be loaded for use with the operation model.

In block 812, the user operates the vehicle. If no assist conditions occur, then in block 828, the trip is finished, and in block 892, the method is done.

However, during user operation in block 812, in some cases a special condition 814 may occur. In that case, in block 816, the AV controller may plan a response action, which may account for the user context.

In block 820, the system may execute the response plan. This can include, for example, emergency braking, emergency lane assist, providing parking assist, providing lane-following assist, or taking some other response action.

In block 824, once the emergency assist or other assist action is complete, then the AV controller hands control back off to the user. User operation may then resume in block 812 as normal.

FIG. 9 is a block diagram of a hardware platform 900. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Hardware platform 900 may provide a suitable structure for controller 104 of FIG. 1, AV controller 200 of FIG. 2, as well as for other computing elements illustrated throughout this specification, including elements external to AV 102. Depending on the embodiment, elements of hardware platform 900 may be omitted, and other elements may be included.

Hardware platform 900 is configured to provide a computing device. In various embodiments, a “computing device” may be or comprise, by way of nonlimiting example, a computer, system on a chip (SoC), workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 900 is arranged in a point-to-point (PtP) configuration. This PtP configuration is popular for personal computer (PC) and server-type devices, although it is not so limited, and any other bus type may be used. The PtP configuration may be an internal device bus that is separate from CAN bus 170 of FIG. 1, although in some embodiments they may interconnect with one another.

Hardware platform 900 is an example of a platform that may be used to implement embodiments of the teachings of this specification. For example, instructions could be stored in storage 950. Instructions could also be transmitted to the hardware platform in an ethereal form, such as via a network interface, or retrieved from another source via any suitable interconnect. Once received (from any source), the instructions may be loaded into memory 904, and may then be executed by one or more processor 902 to provide elements such as an operating system 906, operational agents 908, or data 912.

Hardware platform 900 may include several processors 902. For simplicity and clarity, only processors PROC0 902-1 and PROC1 902-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 902 may be any type of processor and may communicatively couple to chipset 916 via, for example, PtP interfaces. Chipset 916 may also exchange data with other elements. In alternative embodiments, any or all of the PtP links illustrated in FIG. 9 could be implemented as any type of bus, or other configuration rather than a PtP link. In various embodiments, chipset 916 may reside on the same die or package as a processor 902 or on one or more different dies or packages. Each chipset may support any suitable number of processors 902. A chipset 916 (which may be a chipset, uncore, Northbridge, Southbridge, or other suitable logic and circuitry) may also include one or more controllers to couple other components to one or more central processor units (CPU).

Two memories, 904-1 and 904-2 are shown, connected to PROC0 902-1 and PROC1 902-2, respectively. As an example, each processor is shown connected to its memory in a direct memory access (DMA) configuration, though other memory architectures are possible, including ones in which memory 904 communicates with a processor 902 via a bus. For example, some memories may be connected via a system bus, or in a data center, memory may be accessible in a remote DMA (RDMA) configuration.

Memory 904 may include any form of volatile or nonvolatile memory including, without limitation, magnetic media (e.g., one or more tape drives), optical media, flash, random-access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, ROM, flash memory, removable media, tape drive, cloud storage, or any other suitable local or remote memory component or components. Memory 904 may be used for short, medium, and/or long-term storage. Memory 904 may store any suitable data or information utilized by platform logic. In some embodiments, memory 904 may also comprise storage for instructions that may be executed by the cores of processors 902 or other processing elements (e.g., logic resident on chipsets 916) to provide functionality.

In certain embodiments, memory 904 may comprise a relatively low-latency volatile main memory, while storage 950 may comprise a relatively higher-latency nonvolatile memory. However, memory 904 and storage 950 need not be physically separate devices, and in some examples may simply represent a logical separation of function (if there is any separation at all). It should also be noted that although DMA is disclosed by way of nonlimiting example, DMA is not the only protocol consistent with this specification, and that other memory architectures are available.

Certain computing devices provide main memory 904 and storage 950, for example, in a single physical memory device, and in other cases, memory 904 and/or storage 950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Chipset 916 may be in communication with a bus 928 via an interface circuit. Bus 928 may have one or more devices that communicate over it, such as a bus bridge 932, I/O devices 935, accelerators 946, and communication devices 940, by way of nonlimiting example. In general terms, the elements of hardware platform 900 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 940 can broadly include any communication not covered by a network interface and the various I/O devices described herein. This may include, for example, various universal serial bus (USB), FireWire, Lightning, or other serial or parallel devices that provide communications. In a particular example, communication device 940 may be used to stream and/or receive data within a CAN. For some use cases, data may be streamed using UDP, which is unidirectional and lacks error correction. UDP may be appropriate for cases where latency and overhead are at a higher premium than error correction. If bi-directional and/or error corrected communication are desired, then a different protocol, such as TCP may be preferred.

I/O devices 935 may be configured to interface with any auxiliary device that connects to hardware platform 900 but that is not necessarily a part of the core architecture of hardware platform 900. A peripheral may be operable to provide extended functionality to hardware platform 900 and may or may not be wholly dependent on hardware platform 900. In some cases, a peripheral may itself be a. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

Bus bridge 932 may be in communication with other devices such as a keyboard/mouse 938 (or other input devices such as a touch screen, trackball, etc.), communication devices 940 (such as modems, network interface devices, peripheral interfaces such as PCI or PCIe, or other types of communication devices that may communicate through a network), and/or accelerators 946. In alternative embodiments, any portions of the bus architectures could be implemented with one or more PtP links.

Operating system 906 may be, for example, Microsoft Windows, Linux, UNIX, Mac OS X, iOS, MS-DOS, or an embedded or real-time operating system (including embedded or real-time flavors of the foregoing). For real-time systems such as an AV, various forms of QNX are popular. In some embodiments, a hardware platform 900 may function as a host platform for one or more guest systems that invoke application (e.g., operational agents 908).

Operational agents 908 may include one or more computing engines that may include one or more non-transitory computer-readable mediums having stored thereon executable instructions operable to instruct a processor to provide operational functions. At an appropriate time, such as upon booting hardware platform 900 or upon a command from operating system 906 or a user or security administrator, a processor 902 may retrieve a copy of the operational agent (or software portions thereof) from storage 950 and load it into memory 904. Processor 902 may then iteratively execute the instructions of operational agents 908 to provide the desired methods or functions.

There are described throughout this specification various engines, modules, agents, servers, or functions. Each of these may include any combination of one or more logic elements of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language. These may be used with any compatible operating systems or operating environments. Hardware elements may be designed manually, or with a hardware description language. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

Communication devices 940 may communicatively couple hardware platform 900 to a wired or wireless network or fabric. A “network,” as used throughout this specification, may include any communicative platform operable to exchange data or information within or between computing devices, including any of the protocols discussed in connection with FIG. 1 above. A network interface may include one or more physical ports that may couple to a cable (e.g., an Ethernet cable, other cable, or waveguide), or a wireless transceiver.

In some cases, some or all of the components of hardware platform 900 may be virtualized, in particular the processor(s) and memory. For example, a virtualized environment may run on OS 906, or OS 906 could be replaced with a hypervisor or virtual machine manager. In this configuration, a virtual machine running on hardware platform 900 may virtualize workloads. A virtual machine in this configuration may perform essentially all the functions of a physical hardware platform.

In a general sense, any suitably configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 9 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

### Selected Examples

There is disclosed, in an example, a vehicle controller for a vehicle, comprising: a hardware platform, comprising a processor and a memory; and instructions encoded within the memory to: provide an AV control module with at least L4 vehicle control capability; select a semi-autonomous operating mode that uses a subset of the L4 vehicle control capability; and operate the vehicle in the semi-autonomous operating mode.

There is also disclosed an example of the vehicle controller, wherein the AV control module comprises a deep learning (DL) engine configured to analyze driving behavior of external vehicles.

There is also disclosed an example of the vehicle controller, wherein the instructions are further to apply the DL engine to an operator of the vehicle, and create an operator profile.

There is also disclosed an example of the vehicle controller, wherein the instructions are further to make decisions to override operator control, or to permit the operator to override semi-autonomous control, according to the operator profile.

There is also disclosed an example of the vehicle controller, wherein the semi-autonomous operating mode comprises an automatic throttle mode.

There is also disclosed an example of the vehicle controller, wherein the instructions are further to receive a throttle control input from an operator of the vehicle, and to override automatic throttle for a duration of the throttle control input.

There is also disclosed an example of the vehicle controller, wherein the instructions are further to selectively override the automatic throttle according to a DL-based operator profile for the operator.

There is also disclosed an example of the vehicle controller, wherein the semi-autonomous operating mode comprises an automatic steering mode.

There is also disclosed an example of the vehicle controller, wherein the instructions are further to receive an steering control input from an operator, and to override automatic steering control for a duration of the steering control input.

There is also disclosed an example of the vehicle controller, wherein the instructions are further to selectively override the automatic steering control according to a DL-based operator profile for the operator.

There is also disclosed an example of the vehicle controller, wherein the semi-autonomous operating mode comprises an emergency driver-assist response mode.

There is also disclosed an example of the vehicle controller, wherein the instructions are further to condition the emergency driver-assist response mode according to a DL-based operator profile for an operator of the vehicle.

There is also disclosed an example of a method of providing computer-assisted control of a vehicle, comprising: selecting a semi-autonomous operating mode of a vehicle controller with a full autonomous operation capability, wherein the semi-autonomous operating mode comprises a subset of the full autonomous operation capability; identifying an operator of the vehicle, and loading an operator profile for the operator; operating the vehicle according to the semi-autonomous operating mode and the operator profile.

There is also disclosed an example of the method, further comprising applying a deep learning (DL) model to create the operator profile, wherein the DL model is designed to analyze external vehicle behavior.

There is also disclosed an example of the method, further comprising applying the DL model to an operator of the vehicle to create the operator profile.

There is also disclosed an example of the method, further comprising making decisions to override operator control, or permitting the operator to override semi-autonomous control, according to the operator profile.

There is also disclosed an example of the method, wherein the semi-autonomous operating mode comprises an automatic throttle control mode.

There is also disclosed an example of the method, further comprising receiving an operator throttle control input, and overriding automatic throttle control for a duration of the operator throttle control input.

There is also disclosed an example of the method, further comprising selectively overriding the automatic throttle control according to the operator profile.

There is also disclosed an example of the method, wherein the semi-autonomous operating mode comprises an automatic steering control mode.

There is also disclosed an example of the method, further comprising receiving an operator steering control input, and overriding automatic steering control for a duration of the operator steering control input.

There is also disclosed an example of the method, further comprising selectively overriding the automatic steering control according to the operator profile.

There is also disclosed an example of the method, wherein the semi-autonomous operating mode comprises an emergency driver-assist response mode.

There is also disclosed an example of the method, further comprising conditioning the emergency driver-assist response mode according to the operator profile.

There is also disclosed an example of an apparatus comprising means for performing the method.

There is also disclosed an example of the apparatus, wherein the means for performing the method comprise a processor and a memory.

There is also disclosed an example of the apparatus, wherein the memory comprises machine-readable instructions that, when executed, cause the apparatus to perform the method.

There is also disclosed an example of the apparatus, wherein the apparatus is a computing system.

There is also disclosed an example of at least one computer-readable medium comprising instructions that, when executed, implement a method or realize an apparatus as described.

There is also disclosed an example of one or more non-transitory computer-readable storage media having stored thereon executable instructions to: provide a semi-autonomous vehicle operation module being a subset of an L4 or greater autonomous control software, including a vehicle behavior analysis module; apply the vehicle behavior analysis module to an operator of a vehicle to create an operator profile; and semi-autonomously provide L1, L2, or L3 control of the vehicle according to the semi-autonomous vehicle operation module and the operator profile.

There is also disclosed an example of the one or more non-transitory computer-readable storage media, wherein the vehicle behavior analysis module comprises a deep learning (DL) model.

There is also disclosed an example of the one or more non-transitory computer-readable storage media, wherein the executable instructions are further to apply the DL model to the operator to create the operator profile.

There is also disclosed an example of the one or more non-transitory computer-readable storage media, wherein the executable instructions are further to make decisions to override operator control, or to permit the operator to override semi-autonomous control, according to the operator profile.

There is also disclosed an example of the one or more non-transitory computer-readable storage media, wherein the semi-autonomous vehicle operation comprises an automatic throttle control mode.

There is also disclosed an example of the one or more non-transitory computer-readable storage media, wherein the executable instructions are further to receive an operator throttle control input, and to override automatic throttle control for a duration of the operator throttle control input.

There is also disclosed an example of the one or more non-transitory computer-readable storage media, wherein the executable instructions are further to selectively override the automatic throttle control according to the operator profile.

There is also disclosed an example of the one or more non-transitory computer-readable storage media, wherein the semi-autonomous vehicle operation comprises an automatic steering control mode.

There is also disclosed an example of the one or more non-transitory computer-readable storage media, wherein the executable instructions are further to receive an operator steering control input, and to override automatic steering control for a duration of the operator steering control input.

There is also disclosed an example of the one or more non-transitory computer-readable storage media, wherein the executable instructions are further to selectively override the automatic steering control according to the operator profile.

There is also disclosed an example of the one or more non-transitory computer-readable storage media, wherein the semi-autonomous vehicle operation comprises an emergency driver-assist response mode.

There is also disclosed an example of the one or more non-transitory computer-readable storage media, wherein the executable instructions are further to condition the emergency driver-assist response mode according to the operator profile.

Variations and Implementations

As will be appreciated by one skilled in the art, aspects of the present disclosure, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module,” or “system.” In at least some cases, a “circuit” may include both the physical hardware of the circuit, plus any hardware or firmware that programs or configures the circuit. For example, a network circuit may include the physical network interface circuitry, as well as the logic (software and firmware) that provides the functions of a network stack.

Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The foregoing detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While components, arrangements, and/or features are described below in connection with various example embodiments, these are merely examples used to simplify the present disclosure and are not intended to be limiting.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The “means for” in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A vehicle controller for a vehicle, comprising:
a hardware platform, comprising a processor and a memory; and
instructions encoded within the memory to:
provide an autonomous vehicle control module with at least L4 vehicle control capability;
select a semi-autonomous operating mode that uses a subset of the L4 vehicle control capability; and
operate the vehicle in the semi-autonomous operating mode.

2. The vehicle controller of claim 1, wherein the autonomous vehicle control module comprises a deep learning (DL) engine configured to analyze driving behavior of external vehicles.

3. The vehicle controller of claim 2, wherein the instructions are further to apply the DL engine to an operator of the vehicle, and create an operator profile.

4. The vehicle controller of claim 3, wherein the instructions are further to make decisions to override operator control, or to permit the operator to override semi-autonomous control, according to the operator profile.

5. The vehicle controller of claim 1, wherein the semi-autonomous operating mode comprises an automatic throttle mode.

6. The vehicle controller of claim 5, wherein the instructions are further to receive a throttle control input from an operator of the vehicle, and to override automatic throttle for a duration of the throttle control input.

7. The vehicle controller of claim 6, wherein the instructions are further to selectively override the automatic throttle according to a DL-based operator profile for the operator.

8. The vehicle controller of claim 1, wherein the semi-autonomous operating mode comprises an automatic steering mode.

9. The vehicle controller of claim 8, wherein the instructions are further to receive an steering control input from an operator, and to override automatic steering control for a duration of the steering control input.

10. The vehicle controller of claim 9, wherein the instructions are further to selectively override the automatic steering control according to a DL-based operator profile for the operator.

11. The vehicle controller of claim 1, wherein the semi-autonomous operating mode comprises an emergency driver-assist response mode.

12. The vehicle controller of claim 11, wherein the instructions are further to condition the emergency driver-assist response mode according to a DL-based operator profile for an operator of the vehicle.

13. A method of providing computer-assisted control of a vehicle, comprising:
selecting a semi-autonomous operating mode of a vehicle controller with a full autonomous operation capability, wherein the semi-autonomous operating mode comprises a subset of the full autonomous operation capability;
identifying an operator of the vehicle, and loading an operator profile for the operator; and
operating the vehicle according to the semi-autonomous operating mode and the operator profile.

14. The method of claim 13, further comprising applying a deep learning (DL) model to create the operator profile, wherein the DL model is designed to analyze external vehicle behavior.

15. The method of claim 14, further comprising applying the DL model to an operator of the vehicle to create the operator profile.

16. The method of claim 13, further comprising making decisions to override operator control, or permitting an operator to override semi-autonomous control, according to the operator profile.

17. One or more non-transitory computer-readable storage media having stored thereon executable instructions to:
provide a semi-autonomous vehicle operation module being a subset of an L4 or greater autonomous control software, including a vehicle behavior analysis module;
apply the vehicle behavior analysis module to an operator of a vehicle to create an operator profile; and
semi-autonomously provide L1, L2, or L3 control of the vehicle according to the semi-autonomous vehicle operation module and the operator profile.

18. The one or more non-transitory computer-readable storage media of claim 17, wherein the vehicle behavior analysis module comprises a deep learning (DL) model.

19. The one or more non-transitory computer-readable storage media of claim 18, wherein the executable instructions are further to apply the DL model to the operator to create the operator profile.

20. The one or more non-transitory computer-readable storage media of claim 17, wherein the executable instructions are further to make decisions to override operator control, or to permit the operator to override semi-autonomous control, according to the operator profile.
